(19) United States
(12) Patent Application Publication
(10) Pub. No.: US 2007/0021024 A1
(43) Pub. Date: Jan. 25, 2007

(54) Method of manufacturing display panel and anode panel

(76) Inventors: Atsushi Kazawa, Moka (JP); Tatsuya Nagata, Ishioka (JP); Takaaki Kitada, Oamishirasato (JP); Shigemi Hirasawa, Chiba (JP); Takashi Naitou, Mito (JP); Keiichi Kanazawa, Ome (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/488,624

(22) Filed: Jul. 19, 2006

(30) Foreign Application Priority Data
Jul. 21, 2005 (JP) 2005-210878

(51) Int. Cl. H01J 9/24

(52) U.S. Cl. 445/24

(57) ABSTRACT

There is provided a method of manufacturing a display panel and an anode panel for improving reliability of a sealing portion of the display panel. Vacuuming (evacuation of air) is performed to inside of a cavity formed by a cathode panel and an anode panel in a state of viscosity in which a sealant melts and deforms in manufacturing of a display.

### BACKGROUND OF THE INVENTION

1. Field of the invention

The present invention relates to a method of manufacturing a display panel and an anode panel, and in particular, to an effective technology applicable to a field emission display (FED).

2. Description of related art

A field emission display panel has a structure in which a cathode panel having a large number of electron sources for emitting electrons formed thereon and an anode panel having a phosphor applied thereto are placed opposed each other via a gap. It emits light as the phosphor is hit by the electrons emitted from the electron sources corresponding to the respective pixels so as to display an image.

A basic structure of the field emission display panel is described in Denshi Zairyo Issued by Kogyo Chosakai Publishing Co., Ltd. April 2004 pp. 94 to 102, “Feature: Basic Knowledge of the Electronic Display for Young Engineers” for instance.

As for a public-domain document related to the present invention, there is JP-A-7-211270 for instance. It discloses a technology wherein “a cathode-ray tube has its form before sealing of a glass display panel rendered convex outward by a degree of becoming flat in a state of having its inside depressurized after the sealing so that a distance between a filamentary cathode configuring an electron gun unit and a light-emitting surface on a side face in the glass display panel, that is, a range distance of an electron beam becomes constant on one filamentary cathode ray so as to obtain a high image quality.”

### SUMMARY OF THE INVENTION

In the case of a field emission display panel, it is necessary to perform vacuum-lock by securing a gap between electron sources of a cathode panel and a phosphor of an anode panel. In many cases, multiple spacers are placed between the anode panel and the cathode panel to prevent the gap from being crushed by atmospheric pressure. However, there are problems that it is difficult to manufacture, place and assemble the spacers thin enough to be invisible from outside and the spacers charge up to cause distortion of a picture. Thus, there is demand for a display panel structure which requires no spacers or only a small number of spacers.

To realize a spacerless display panel, it is necessary to prevent the gap from being crushed by the atmospheric pressure. The crush of the gap can be prevented by thickening the anode panel and the cathode panel and decreasing deflection for atmospheric pressure. However, the display panel itself becomes very heavy in the case of a large-screen panel exceeding 32 inches for instance.

Thus, the panel should be rendered thinner and lighter by increasing strength of glass to the extent of not getting damaged. However, the following problem arises in this case.

When sealing the anode panel and the cathode panel with a sealant in manufacturing a conventional field emission display panel, vacuuming (evacuation of air) is performed to the inside of a cavity formed by the anode panel and the cathode panel after the sealant hardens.

In this case, the panel is deflected by receiving the atmospheric pressure due to the vacuuming. Due to influence of the deflection of the panel, a stress is exerted on a sealing portion in a rotation direction for floating the outside of a seal surface of the sealing portion so that the stress is generated in the direction for peeling off the sealing portion. To be more specific, if the vacuuming is performed to the inside of the cavity after firmly fixing the anode panel and the cathode panel with the sealant (after the sealant hardens), the stress caused by the deflection of the panel concentrates on the sealing portion so that the problem such as a damage on the sealing portion is apt to occur. As this lowers reliability of the sealing portion of the display panel, measures should be taken.

An object of the present invention is to provide a technology capable of improving the reliability of the sealing portion of the display panel.

The above object, other objects and novel features of the present invention will be clarified by descriptions of this specification and the attached drawings.

Of the inventions disclosed in the present application, an overview of a representative one will be described briefly as follows.

The object is attained by performing the vacuuming (evacuation of air) to the inside of a cavity formed by the anode panel and the cathode panel in a state of viscosity in which the sealant melts and deforms. For instance, it is performed as follows.

(1) In manufacturing of a display panel, comprising the steps of:

(a) preparing an anode panel including a first surface, a second surface on an opposite side to the first surface, a concave portion with a dent on the second surface to the first surface side and a third surface on its bottom, and a phosphor provided on the third surface;

(b) preparing a cathode panel having electron sources provided on its principal surface;

(c) sealing the anode panel and the cathode panel by melting a sealant lying between the cathode panel and the second surface of the anode panel in a state of having the electron sources and the phosphor mutually opposed with a distance between them, and wherein:

in the step (c), vacuuming (evacuation of air) is performed to the inside of a cavity formed by the cathode panel and the anode panel in a state of viscosity in which the sealant melts and deforms.

(2) The means according to (1), wherein the sealant is a vitreous glass frit.

(3) The means according to (1), wherein:

the second surface of the anode panel is inclined so as to locate an inner rim on the concave portion side closer to the first surface side than an outer rim on the opposite side to the inner rim in the step (a).

(4) The means according to (1), wherein

the second surface of the anode panel includes the inner rim on the concave portion side and the outer rim on the opposite side to the inner rim;

the inner rim and the outer rim are formed in a square shape; and

the second surface of the anode panel is curved so as to locate a side center of the outer rim closer to the first surface side than angular portions of the outer rim in the step (a).

(5) The means according to (1), wherein

the first surface of the anode panel is formed like a convex curve so as to project the center of the first surface more than its rim in the step (a); and

the third surface of the anode panel is formed like a concave curve so as to dent the center of the third surface more than its rim correspondingly to the first surface in the step (a).

An advantageous effect of the representative one of the inventions disclosed by the present application will be described briefly as follows.

The present invention can improve reliability of the sealing portion of the display panel.

The other objects, features and advantages of the present invention will be clarified by the following descriptions of embodiments of the present invention relating to the attached drawings.

### BRIEF DESCRIPTION OF THE SEVERAL VIEWS OF THE DRAWING

FIG. 1 is an external perspective view of a display apparatus incorporating a display panel according to a first embodiment of the present invention;

FIG. 2 is a schematic plan view showing an overview configuration of the display panel according to the first embodiment of the present invention;

FIG. 3A is a schematic sectional view along a line IIIA-IIIA of FIG. 2, showing the general configuration of the display panel;

FIG. 3B is a schematic sectional view along a line IIIB-IIIB of FIG. 2;

FIG. 4 is a schematic side view of the display panel of FIG. 2 as viewed from an arrow S direction;

FIG. 5 is a schematic plan view of an anode panel before sealing of FIG. 2 as viewed from a display surface side;

FIG. 6 is a schematic bottom view of the anode panel before sealing of FIG. 2 as viewed from a sealing surface side;

FIG. 7A is a schematic sectional view along a line VIIC-VIIC of FIG. 5, showing a general configuration of the anode panel before the sealing of FIG. 2;

FIG. 7B is a schematic sectional view along a line VIID-VIID of FIG. 5;

FIG. 8 is a schematic sectional view of the anode panel before the sealing of FIG. 5 as viewed from the arrow S direction;

FIG. 9A is a schematic sectional view showing a state before evacuation of air, showing a sealing process in manufacturing of the display panel according to the first embodiment of the present invention;

FIG. 9B is a schematic sectional view showing a state after the evacuation of air;

FIG. 10 is a diagram showing a temperature profile in the sealing process of FIGS. 9A and 9B;

FIG. 11A is a schematic sectional view at the same position as FIG. 3A, showing a substantial configuration of the display panel according to a second embodiment of the present invention;

FIG. 11B is a schematic side view viewed from the same direction as FIG. 4;

FIG. 12A is a schematic sectional view at the same position as FIG. 11A, showing a general configuration of the anode panel before the sealing of FIG. 11;

FIG. 12B is a schematic side view viewed from the same direction as FIG. 11B;

FIG. 13A is a schematic sectional view showing the state before evacuation of air, showing the sealing process in manufacturing of the display panel according to the second embodiment of the present invention;

FIG. 13B is a schematic sectional view showing the state after the evacuation of air;

FIG. 14A is a schematic sectional view showing the state before the evacuation of air, showing the sealing process in manufacturing of the display panel according to a third embodiment of the present invention;

FIG. 14B is a schematic sectional view showing the state after the evacuation of air;

FIG. 15 is a schematic sectional view showing a general configuration of the display panel according to a fourth embodiment of the present invention;

FIG. 16 is an expansion plan of the display panel of FIG. 15;

FIG. 17 is a schematic sectional view showing the sealing process in manufacturing of the display panel according to the fourth embodiment of the present invention; and

FIG. 18 is a schematic sectional view showing a general configuration of the display panel as a variation of the fourth embodiment of the present invention.

### DETAILED DESCRIPTION OF THE INVENTION

Embodiments of the present invention will be described in detail below with reference to the drawings. Those having the same functions are given with the same symbols and repeated descriptions thereof will be omitted in all the drawings for describing the embodiments of the invention.

### First Embodiment

The first embodiment will describe an example of applying the present invention to a display panel including a cap-shaped anode panel.

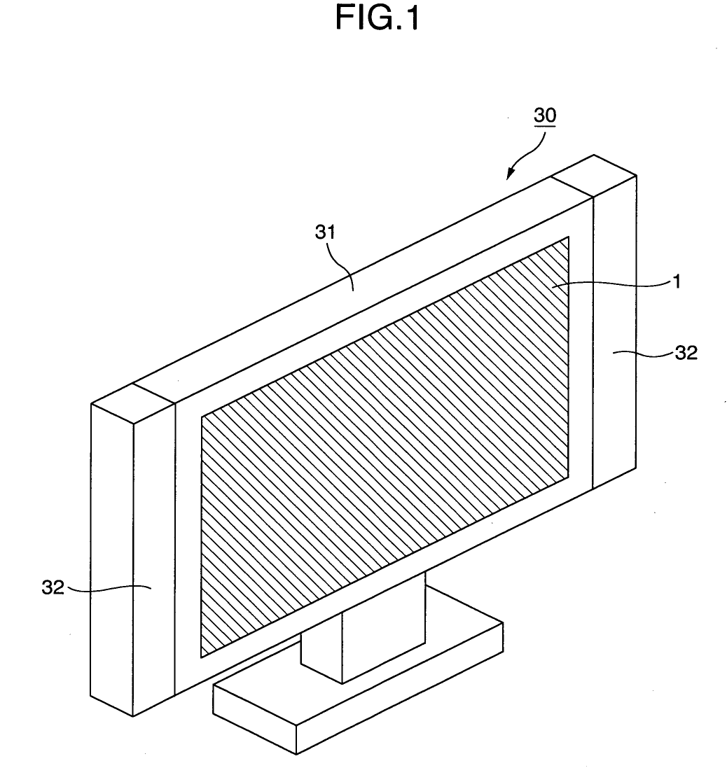

FIGS. 1 to 10 are the drawings related to the display panel of the invention as described in those brief descriptions.

A display apparatus 30 shown in FIG. 1 is an example applied to a TV set, which has a configuration including a housing 31, a display panel 1, speakers 32 and the like. The display panel of the present invention is also applicable as the display apparatus of a personal computer, a DVD and the like other than the TV set,

The display panel 1 is thin and lightweight, and is mounted in the housing 31. The anode panel of the display panel 1 is exposed in a planar state from a front window of the housing 31.

As the display panel 1 is thin, the housing 31 is formed as a thin type in conjunction therewith. A power supply, a TV tuner, a controller and the like are housed inside the housing 31, and are connected to the display panel 1. The speakers 32, for instance, are mounted on both sides of the housing 31.

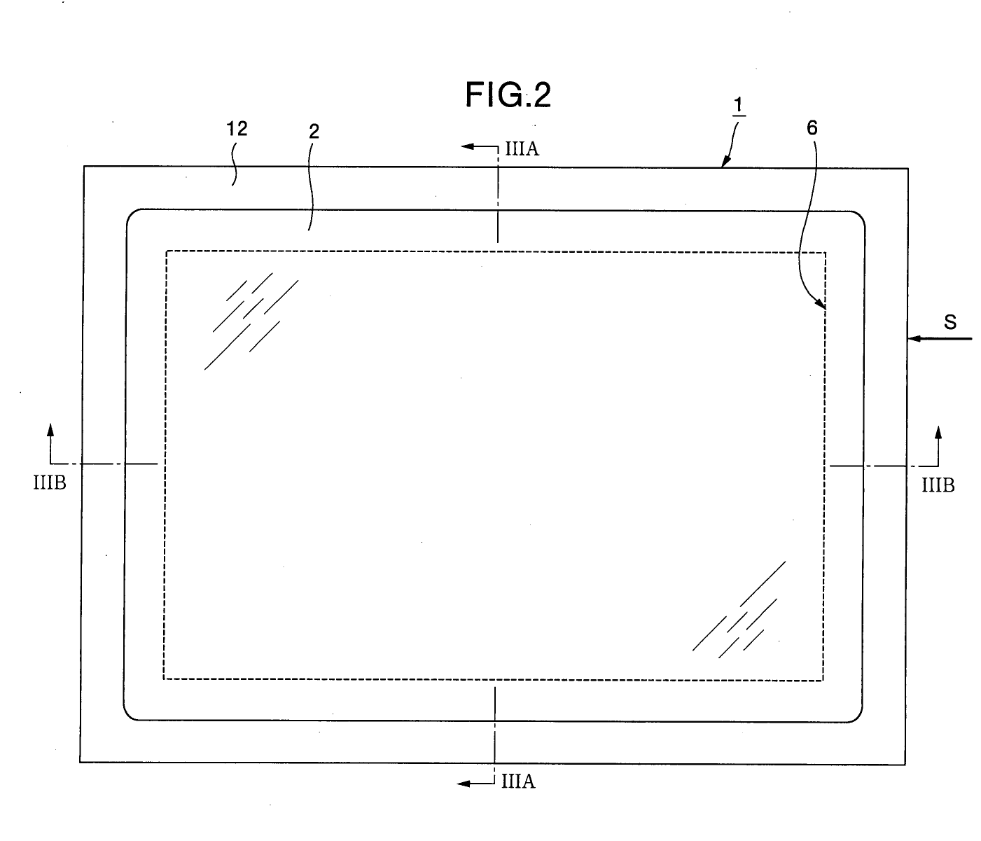

Next, the display panel 1 will be described by using FIGS. 2 to 8.

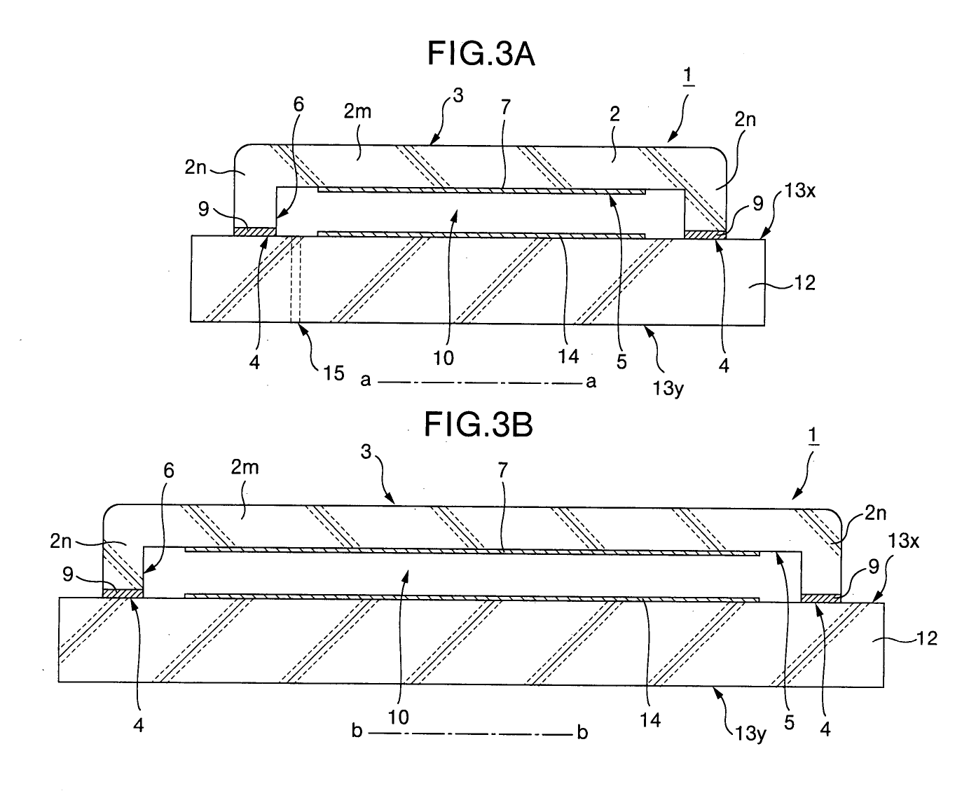

As shown in FIG. 2, the display panel 1 has a square-shaped plan, which is rectangular according to the first embodiment for instance. As shown in FIGS. 3 (FIGS. 3A and 3B), the display panel 1 mainly includes an anode panel 2 forming an image display, a cathode panel 12 opposed to the anode panel 2, a cavity (vacuum room) 10 formed by the anode panel 2 and cathode panel 12, a phosphor 7 provided to the anode panel 2, and electron sources 14 provided to the cathode panel 12.

The phosphor 7 and the electron sources 14 are placed opposite to each other with a distance between them in the cavity 10. The inside of the cavity 10 is more depressurized than the outside, and is nearly vacuum even though not absolute vacuum. The phosphor 7 emits light by receiving an electron beam from the electron sources 14.

As shown in FIG. 2, the anode panel 2 and cathode panel 12 have square-shaped plans, which are rectangular according to the first embodiment for instance. The cathode panel 12 has a larger plan size than the anode panel 2.

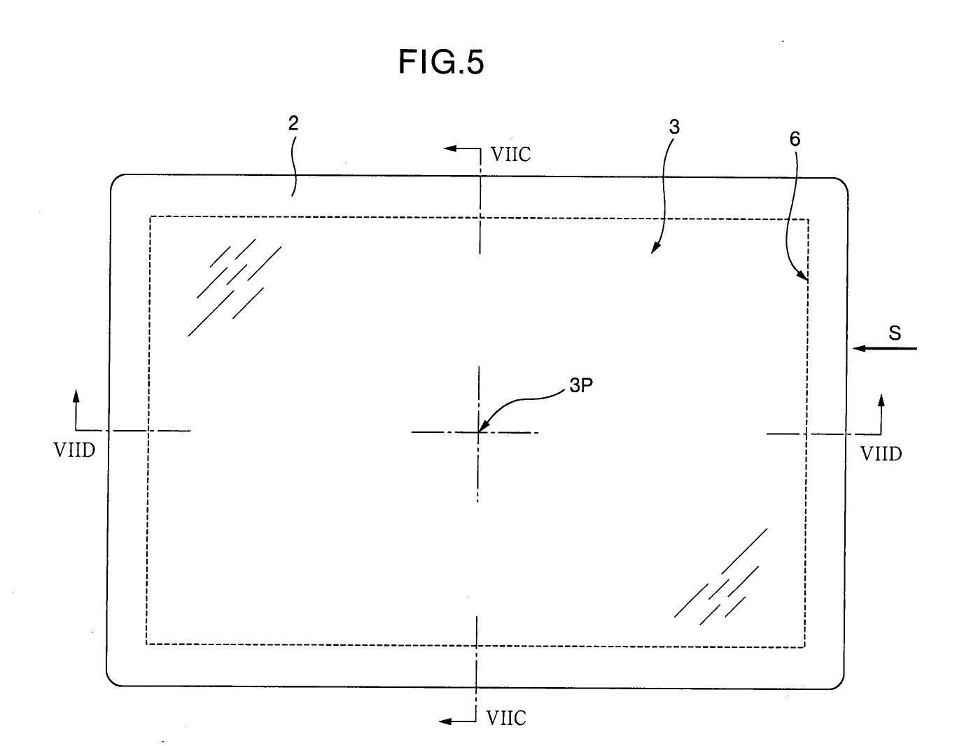

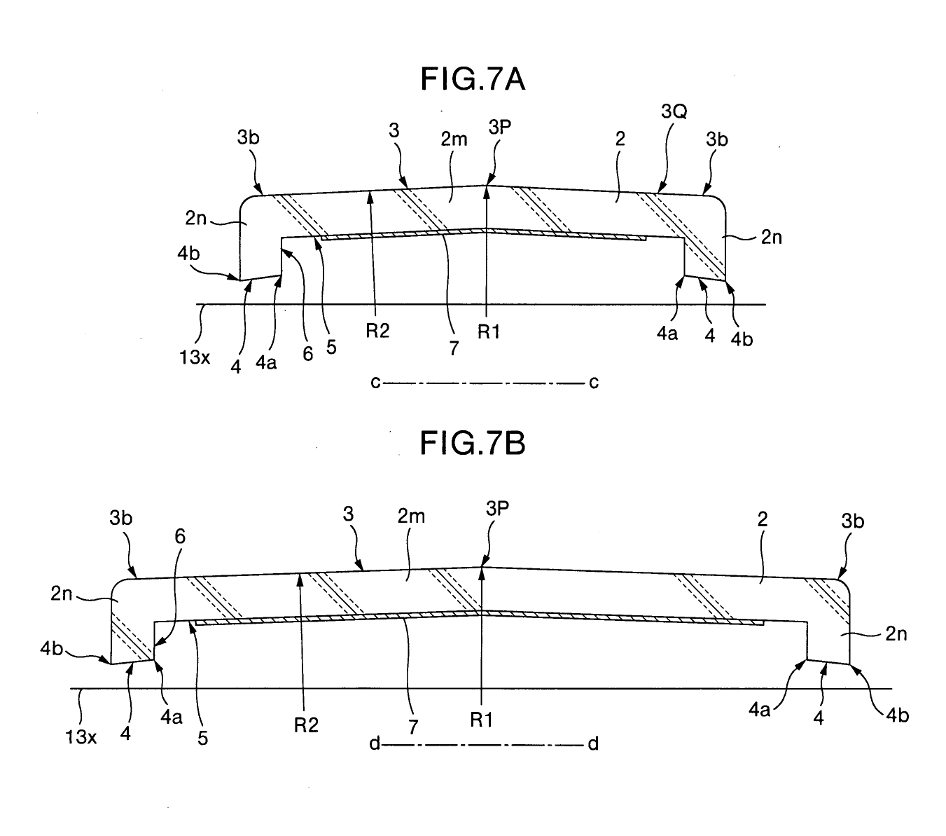

The anode panel 2 is formed by transparent glass. As shown in FIGS. 5, 6 and 7 (FIGS. 7A and 7B), the anode panel 2 includes a first surface (display surface) 3, a second surface (seal surface) 4 on the opposite side to the first surface 3, a concave portion 6 dented on the second surface 4 to the first surface 3 side and a third surface (phosphor forming surface) 5 on its bottom, and the phosphor 7 provided on the third surface 5. To be more specific, the anode panel 2 is cap-shaped, where the concave portion 6 dented on the second surface 4 to the first surface 3 side is provided on the second surface 4 side opposite to the first surface 3 as the display surface.

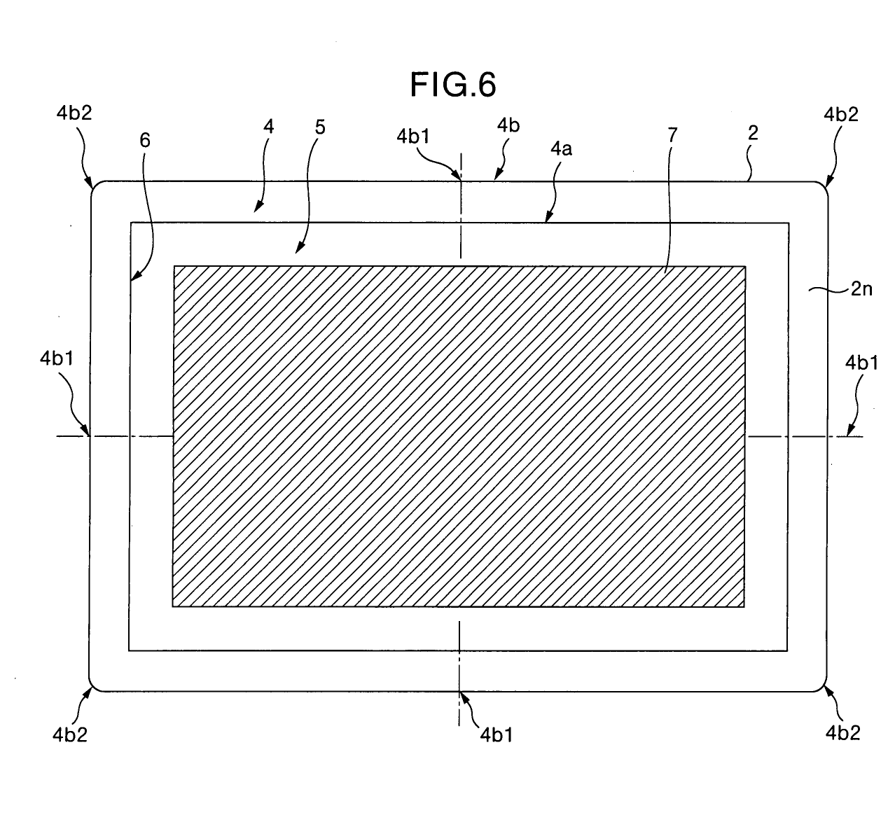

As shown in FIG. 6, the concave portion 6 has a square-shaped plan, which is rectangular according to the first embodiment for instance. As shown in FIGS. 6 and 7 (FIGS. 7A and 7B), the second surface 4 is formed by surrounding the concave portion 6, and includes an inner rim 4a on the concave portion 6 side and an outer rim 4b on the opposite side to the inner rim 4a. To be more specific, the anode panel 2 comprises a base portion (display portion) 2m including the first surface 3 and the third surface 5 and a leg portion (skirt portion) 2n formed like a frame by surrounding the third surface 5 and including the second surface 4.

As shown in FIGS. 3A and 3B, the cathode panel 12 is provided with the electron sources 14 on its principal surface 13x, and is further provided with wiring not shown. The cathode panel 12 is formed like a plan. As for a material of the cathode panel 12, glass is used for instance because of easiness of forming the electron sources 14 and the wiring, consistency of a linear coefficient of expansion with the anode panel 2 and the like.

The anode panel 2 and the cathode panel 12 are sealed (firmly fixed) by a sealant 9 lying between the second surface 4 of the anode panel 2 and the principal surface 13x of the cathode panel 12. The cavity 10 is airtightly sealed by firmly fixing the anode panel 2 and the cathode panel 12 with the sealant 9. A vitreous glass frit which melts gradually along with temperature rise and hardens gradually along with temperature drop is used as the sealant 9 for instance.

The cathode panel 12 is provided with an exhaust hole 15 for performing vacuuming to the inside of the cavity 10. The exhaust hole 15 is formed from the principal surface 13x of the cathode panel 12 to a backside 13y on the opposite side thereof, and is placed by avoiding the electron sources 14 and the wiring. The exhaust hole 15 is closed after performing the vacuuming to the inside of the cavity 10 so as to keep a vacuum state in the cavity 10.

The base portion 2m of the anode panel 2 is formed with a thickness capable of bending without damage after performing the vacuuming to the inside of the cavity 10. The cathode panel 12 is formed with a thickness to be deformed little or almost negligibly by atmospheric pressure.

According to the first embodiment, the forms of the first surface 3, second surface 4 and third surface 5 of the anode panel 2 before the vacuuming and after the vacuuming are different.

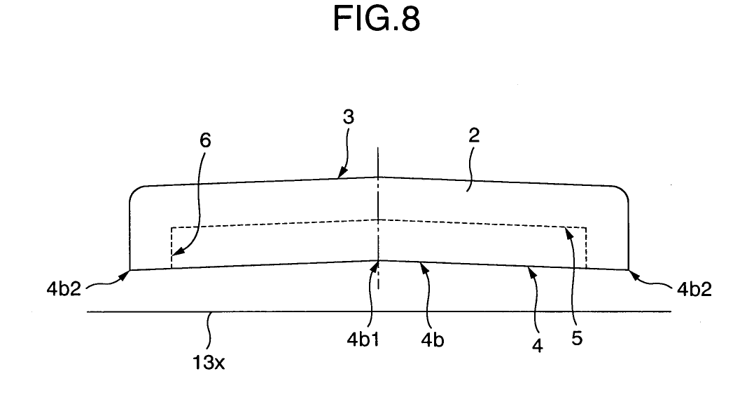

As shown in FIGS. 7A and 7B, the second surface 4 of the anode panel 2 before the vacuuming is inclined so that the inner rim 4a on the concave portion 6 side is located closer to the first surface 3 side than the outer rim 4b on the opposite side. As shown in FIG. 8, the second surface 4 is curved so that a side center 4b1 of the outer rim 4b is located closer to the first surface 3 side than angular portions 4b2 of the outer rim 4b. The first surface 3 is formed like a convex curve so that the center 3P of the first surface 3 is more projected than its rim 3b, and the third surface 5 is formed like a concave curve so that the center of the third surface 5 is more dented than its rim correspondingly to the first surface 3.

Here, a center 3P of the first surface 3 refers to a portion where two diagonals cross on the first surface 3 of which plan is square-shaped. The center of the third surface 5 refers to the portion where the two diagonals cross on the third surface 5 of which plan is square-shaped.

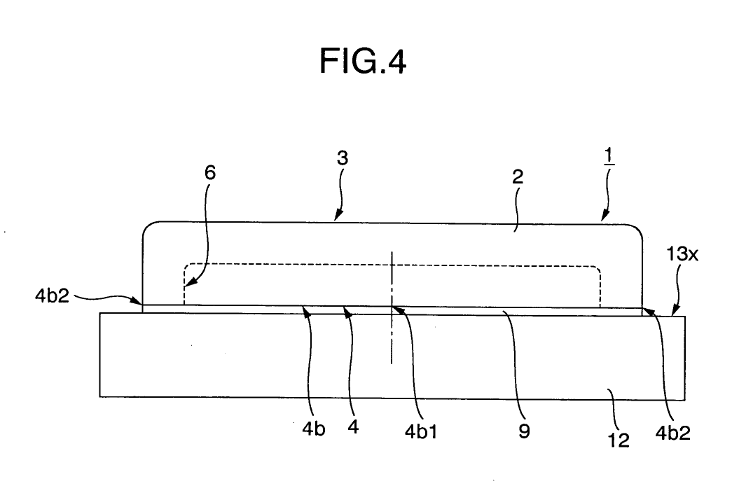

As shown in FIGS. 3 (3A and 3B), the second surface 4 of the anode panel 2 after the vacuuming is flat against the principal surface 13x of the cathode panel 12 in the direction for crossing the inner rim 4a and the outer rim 4b. As shown in FIG. 4, the second surface 4 is flat against the principal surface 13x of the cathode panel 12 in the direction for connecting the two adjacent angular portions 4b2 of the outer rim 4b. As shown in FIGS. 3 (3A and 3B), the first surface 3 and the third surface 5 are flat against the principal surface 13x of the cathode panel 12.

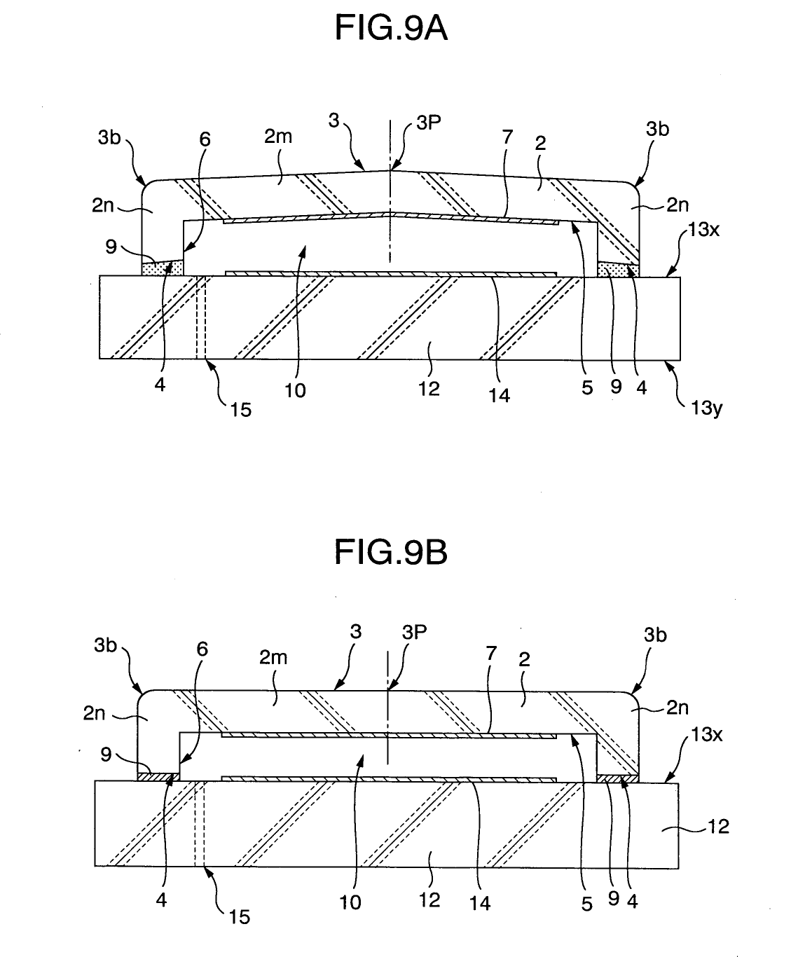

As for the electron sources 14, FIGS. 3 (FIGS. 3A and 3B) and FIGS. 9 (FIGS. 9A and 9B) show a placement area of the electron sources as one for the sake of omission. In reality, however, a large number of electron sources are two-dimensionally arranged. As for the phosphor 7, FIGS. 3 (FIGS. 3A and 3B), FIG. 6, FIGS. 7 (FIGS. 7A and 7B) and FIGS. 9 (FIGS. 9A and 9B) show the placement area of the phosphor as one for the sake of omission. In the case of a color panel for instance, however, the phosphors in red, green and blue are two-dimensionally arranged correspondingly to the electron sources.

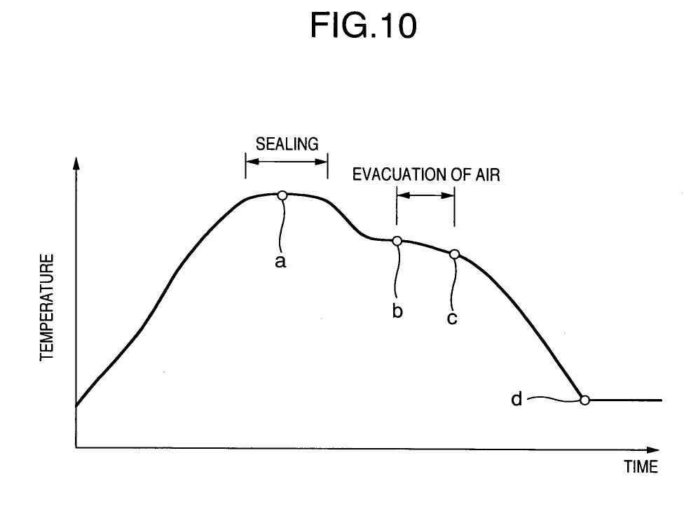

Next, manufacturing (assembly) of the display panel 1 will be described by using FIGS. 9 and 10.

First, the anode panel 2 shown in FIGS. 7 and 8 and the cathode panel 12 shown in FIGS. 3 (FIGS. 3A and 3B) are prepared.

Next, as shown in FIG. 9A, the sealant 9 is put between the principal surface 13x of the cathode panel 12 and the second surface 4 of the anode panel 2, and the anode panel 2 is placed on the principal surface 13x of the cathode panel 12 so that the electron sources 14 and the phosphor 7 are opposed to each other. The vitreous glass frit is used as the sealant 9.

Next, the sealant 9 lying between the principal surface 13x of the cathode panel 12 and the second surface 4 of the anode panel 2 is melted in the state where the electron sources 14 and the phosphor 7 are opposed to each other with a distance between them. Thus, the principal surface 13x of the cathode panel 12 and the second surface 4 of the anode panel 2 are firmly fixed as shown in FIG. 9B. As shown in FIG. 10, the cathode panel 12 and the anode panel 2 are firmly fixed by increasing the temperature to sealing temperature of the sealant 9 (point a in FIG. 10: 430° C. for instance) to melt the sealant 9 and then lowering the temperature to cool it to ordinary temperature (point d in FIG. 10) to solidify the sealant 9.

In this process, the vacuuming (evacuation of air) is performed to the inside of the cavity 10 formed by the cathode panel 12 and the anode panel 2 in the state of viscosity in which the sealant 9 melts and deforms. As shown in FIG. 10 for instance, the sealant 9 is melted, and then the vacuuming is started (point b in FIG. 10: 350° C. for instance) and the vacuuming is finished (point c in FIG. 10: 340° C. for instance) during the temperature in the state of viscosity in which the sealant 9 deforms in a temperature lowering process. After finishing the vacuuming, it is cooled to the ordinary temperature so as to close the exhaust hole 15.

Here, the anode panel 2 bends as it receives the atmospheric pressure due to the influence of the vacuuming of the inside of the cavity 10. If the vacuuming is performed to the inside of the cavity 10 after the sealant 9 solidifies, a stress is exerted on the sealing portion in the rotation direction for floating the outer rim 4b of the second surface 4 of the anode panel 2 due to the influence of the bending of the anode panel 2 so that a stress is generated in the direction for peeling off the sealing portion.

In comparison, if the vacuuming is performed to the inside of the cavity 10 in the state of viscosity in which the sealant 9 melts and deforms as with the first embodiment, the outer rim 4b of the second surface 4 of the anode panel 2 floats due to the influence of the bending of the anode panel 2 so that no stress is left in the direction for peeling off the sealing portion after the sealant 9 solidifies. Therefore, it is possible to prevent the problems such as the damage of the sealing portion due to the stress caused by the bending of the anode panel 2 so as to improve reliability of the sealing portion of the display panel 1.

It is possible to check whether or not the vacuuming is performed in the state of viscosity in which the sealant 9 melts and deforms as follows for instance. When the vacuuming is performed in the state where the sealant 9 does not deform and the second surface 4 of the anode panel 2 is fixed, the greatest tensile stress generated to the anode panel 2 is generated on an external periphery 3Q (periphery of the first surface 3 which is a portion inside the inner rim 4a of the second surface 4) as shown in the sectional view of FIG. 7A. When the vacuuming is performed in the state where the sealant 9 can deform and the second surface 4 of the anode panel 2 is not fixed, the tensile stress of an inner surface center 5P (center of the third surface 5) becomes greater than that of the external periphery 3Q. Thus, it can be checked by measuring whether the tensile stress of the external periphery 3Q is lower than that of the inner surface center 5P. As a compression stress of which absolute value is equal to the inner surface center 5P is generated in an outer surface center 3P (center of the first surface 3), a comparison may be made between the outer surface center 3P and the external periphery 3Q to measure the stress in reality. It is possible, for instance, to attach a strain gauge to the outer surface center 3P and the external periphery 3Q of an evacuated display panel and then disassemble it for the sake of releasing the stress of the panel so as to measure the stress generated to the panel from change in strain gauge measured values before and after the disassembly.

As shown in FIGS. 9A and 9B, the anode panel 2 has the base portion 2m bent to the cavity 10 side by receiving the atmospheric pressure due to the influence of the vacuuming of the inside of the cavity 10. Therefore, to render the first surface 3 and the third surface 5 flat in the state where the anode panel 2 receives the atmospheric pressure after the vacuuming, the first surface 3 is formed in advance like a convex curve so that the center 3P of the first surface 3 is more projected than its rim 3b, and the third surface 5 is formed in advance like a concave curve so that the center of the third surface 5 is more dented than its rim correspondingly to the first surface 3 (refer to FIGS. 7A and 7B). Thus, the first surface 3 is formed in advance like a convex curve and the third surface 5 is formed in advance like a concave curve correspondingly to the first surface so that the first surface 3 and the third surface 5 become flat against the principal surface 13x of the cathode panel 12 in the state where the anode panel 2 receives the atmospheric pressure after the vacuuming. It is thereby possible to render spaces between the electron sources 14 and the phosphor 7 even so as to obtain the display panel 1 of a good quality without unevenness in luminance.

If the anode panel 2 receives the atmospheric pressure in the state where the second surface 4 is not fixed, a maximum stress generating point of the anode panel 2 moves from the outer surface (first surface 3) of the anode panel 2 to the inner surface center (center of the third surface 5). The anode panel 2 is formed by press work using a mold, and is then produced by performing a polishing process to render the first surface 3 convex curve-shaped. The first surface 3 is a polished surface while the third surface 5 is a pressed surface. As the third surface 5 is not polished, it has no polishing flaw and its breaking strength is higher than the first surface 3. Therefore, the thickness of the anode panel 2 can be reduced to that extent.

As for the concave curve shape of the first surface 3, it is desirable that a curvature R1 of the center 3P be larger than a curvature R2 of its surrounding portion with reference to FIG. 7A (R1>R2).

As shown in FIGS. 9 9A and 9B, the anode panel 1 has the outer rim 4b of the second surface 4 bent as if floating by receiving the atmospheric pressure due to the influence of the vacuuming of the inside of the cavity 10. Therefore, as shown in FIGS. 7 (7A and 7B), the second surface 4 is inclined in advance so that the inner rim 4a is located closer to the first surface 3 side than the outer rim 4b in order to render the second surface 4 flat in the state where the anode panel 2 is receiving the atmospheric pressure after the vacuuming. Thus, as the first surface 4 is inclined, the second surface 4 becomes flat against the principal surface 13x of the cathode panel 12 in the direction for crossing the inner rim 4a and the outer rim 4b (width direction of the second surface 4) in the state where the anode panel 2 is receiving the atmospheric pressure after the vacuuming. Therefore, the thickness of the sealant 9 becomes less and even from the inner rim 4a to the outer rim 4b of the second surface 4 so as to enhance the strength of the sealing portion.

The anode panel 2 has the angular portions 4b2 of the second surface 4 bent as if floating by receiving the atmospheric pressure due to the influence of the vacuuming of the inside of the cavity 10. Therefore, as shown in FIG. 8, the second surface 4 is curved in advance so that the side center 4b1 of the outer rim 4b is located closer to the first surface 3 side than the angular portions 4b2 of the outer rim 4b in order to render the second surface 4 flat in the state where the anode panel 2 is receiving the atmospheric pressure after the vacuuming. Thus, as the second surface 4 is curved, the second surface 4 becomes flat against the principal surface 13x of the cathode panel 12 in the direction for connecting the two adjacent angular portions 4b2 of the outer rim 4b (longitudinal direction of the second surface 4) in the state where the anode panel 2 is receiving the atmospheric pressure after the vacuuming. Therefore, the thickness of the sealant 9 becomes less and even in the longitudinal direction of the second surface 4 so as to enhance the strength of the sealing portion.

Thus, the second surface 4 is inclined in advance so that the inner rim 4a is located closer to the first surface 3 side than the outer rim 4b, and the second surface 4 is curved in advance so that the side center 4b1 of the outer rim 4b is located closer to the first surface 3 side than the angular portions 4b2 of the outer rim 4b. As a result, the thickness of the sealant 9 becomes less and even over the entire circumference of the anode panel 2. Therefore, it is possible to prevent a problem such as dragging the sealant 9 therein during the vacuuming and forming a leak path.

The convex curve and concave curve of the first surface 3 and the third surface 5 of the anode panel 2 can be controlled by the shape of a press die. However, the first surface 3 is an image display surface of the display which normally needs to be polished. In that case, it is possible to use a method of polishing it by pressing the panel against a polishing platform. It is possible to use a curved-surfaced polishing platform or polish it on a flat polishing platform after evacuating the third surface 5 side of the anode panel 2 with a jig and putting it under the atmospheric pressure so as to obtain a shape which becomes flat after sealing evacuation.

As the second surface 4 cannot normally have its shape controlled during the press work, it requires the polishing. As for a working method of an oblique shape and a curved shape of the second surface 4, it is possible likewise to polish it on the curved-surfaced platform or polish it on a flat polishing platform by pressing it against the polishing platform and putting it under the atmospheric pressure from the first surface 3 side of the anode panel 2 so as to obtain a shape which becomes flat after sealing evacuation.

### Second Embodiment

The first embodiment described the example in which the second surface 4 is inclined and curved in advance so that the second surface 4 become flat against the principal surface 13x of the cathode panel 12 in the state where the anode panel 2 receives the atmospheric pressure after the vacuuming. A second embodiment will describe an example of using the anode panel 2 in which the second surface 4 is flat against the principal surface 13x of the cathode panel 12 before the vacuuming.

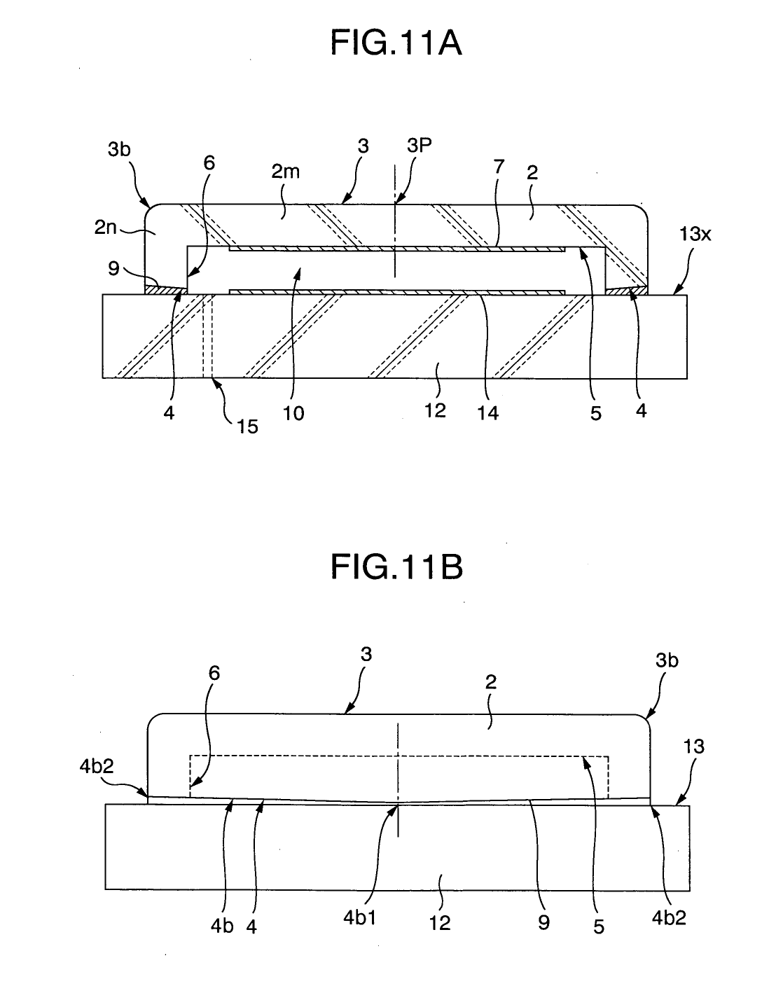

FIGS. 11 to 13 are diagrams related to the display panel according to the second embodiment of the present invention.

FIGS. 11 are diagrams showing an overview configuration of the display panel (FIG. 11A is a schematic sectional view at the same position as FIG. 3A and FIG. 11B is a schematic side view viewed from the same direction as FIG. 4).

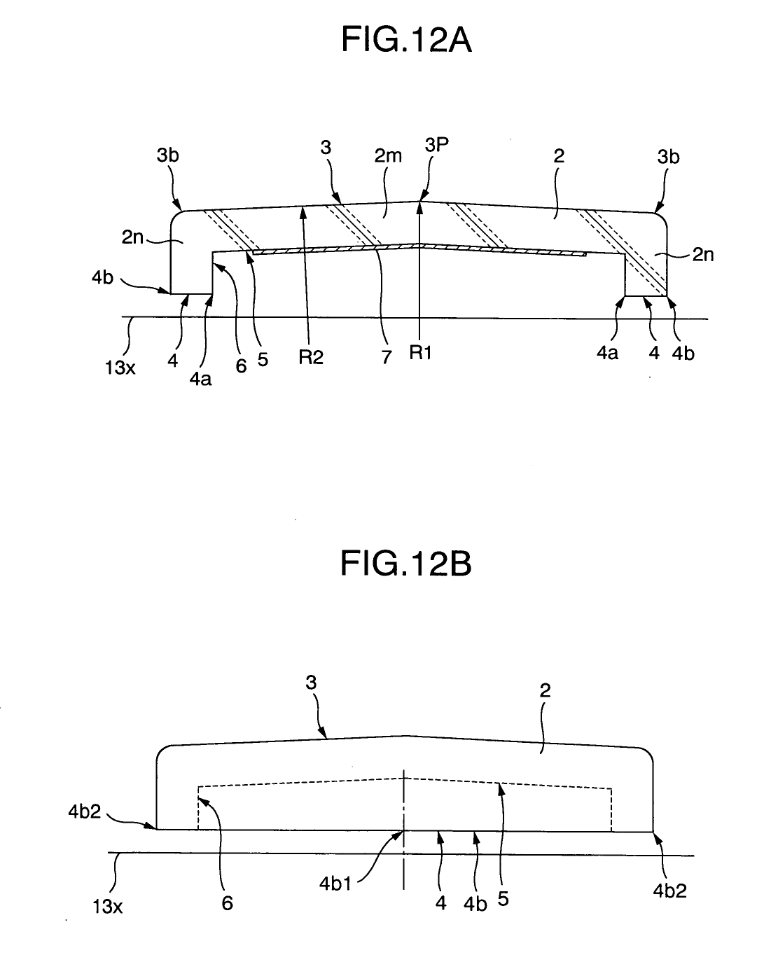

FIGS. 12A and 12B are diagrams showing an overview configuration of the anode panel of FIG. 11 before the sealing. FIG. 12A is a schematic sectional view at the same position as FIG. 11A, and FIG. 12B is a schematic side view viewed from the same direction as FIG. 11B.

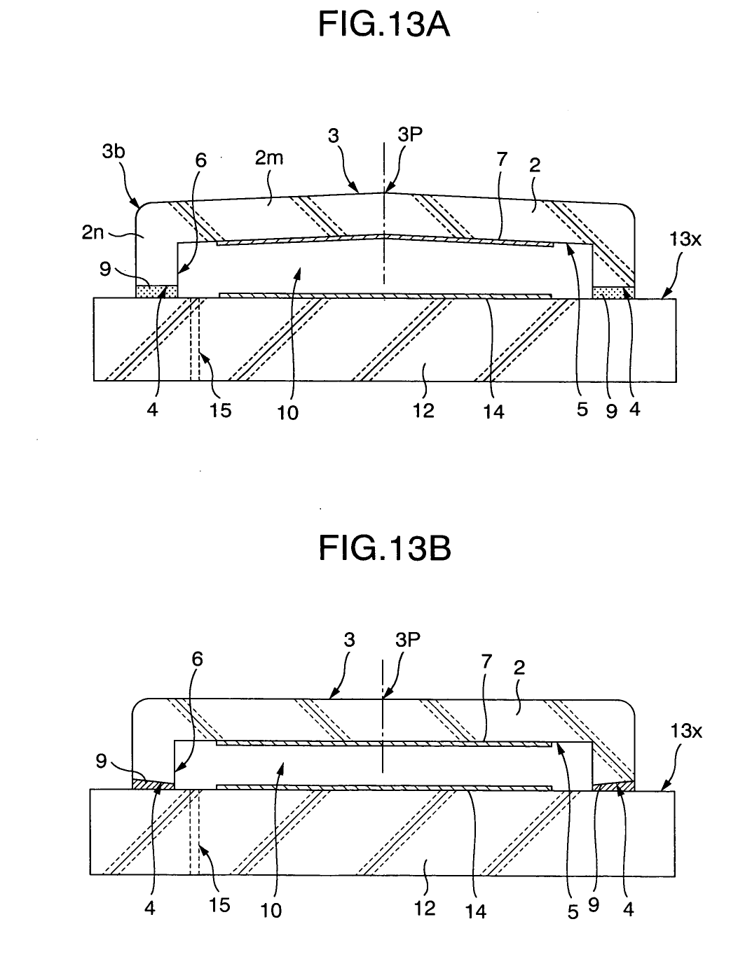

FIGS. 13 are diagrams showing the sealing process in the manufacturing of the display panel (FIG. 13A is a schematic sectional view showing the state before the evacuation of air and FIG. 13B is a schematic sectional view showing the state after the evacuation of air).

As shown in FIG. 12A, on the anode panel 2 before the vacuuming, the second surface 4 is flat against the principal surface 13x of the cathode panel 12 in the direction for crossing the inner rim 4a and the outer rim 4b. As shown in FIG. 12B, the second surface 4 is flat against the principal surface 13x of the cathode panel 12 in the direction for connecting the two adjacent angular portions 4b2 of the outer rim 4b. The first surface 3 is formed like a convex curve with the center 3P of the first surface 3 more projected than its rim 3b, and the third surface 5 is formed like a concave curve with the center of the third surface 5 more dented than its rim correspondingly to the first surface 3.

As shown in FIG. 11A, on the anode panel 2 after the vacuuming, the second surface 4 is inclined so that the outer rim 4b is located closer to the first surface 3 side than the inner rim 4a on the concave portion 6 side. As shown in FIG. 11B, the second surface 4 is curved so that the angular portions 4b2 of the outer rim 4b are located closer to the first surface 3 side than the side center 4b1 of the outer rim 4b. As shown in FIG. 11A, the first surface 3 and the third surface 5 are flat against the principal surface 13x of the cathode panel 12.

Next, the manufacturing (assembly) of the display panel 1 of the second embodiment will be described by using FIG. 13.

First, the anode panel 2 shown in FIGS. 12 (12A and 12B) and the cathode panel 12 shown in FIGS. 11 (FIGS. 11A and 11B) are prepared.

Next, as shown in FIG. 13A, the sealant 9 is put between the principal surface 13x of the cathode panel 12 and the second surface 4 of the anode panel 2, and the anode panel 2 is placed on the principal surface 13x of the cathode panel 12 so that the electron sources 14 and the phosphor 7 are opposed to each other. The vitreous glass frit is used as the sealant 9.

Next, the sealant 9 lying between the principal surface 13x of the cathode panel 12 and the second surface 4 of the anode panel 2 is melted in the state where the electron sources 14 and the phosphor 7 are opposed to each other with a distance between them. Thus, the principal surface 13x of the cathode panel 12 and the second surface 4 of the anode panel 2 are firmly fixed as shown in FIG. 13B. As with the aforementioned first embodiment, the cathode panel 12 and the anode panel 2 are firmly fixed by performing the vacuuming (evacuation of air) to the inside of the cavity 10 formed by the cathode panel 12 and the anode panel 2 in the state of viscosity in which the sealant 9 melts and deforms (refer to FIG. 10).

In this process, the anode panel 2 is bent by receiving the atmospheric pressure due to the influence of the vacuuming of the inside of the cavity 10. As the vacuuming is performed to the inside of the cavity 10 in the state of viscosity in which the sealant 9 melts and deforms, however, the outer rim 4b of the second surface 4 of the anode panel 2 floats due to the influence of the bending of the anode panel 2. Therefore, no stress is left in the direction for peeling off the sealing portion after the sealant 9 solidifies according to the second embodiment. For this reason, it is possible, as with the aforementioned first embodiment, to prevent the problems such as the damage of the sealing portion due to the stress caused by the bending of the anode panel 2.

In this process, as shown in FIGS. 13A and 13B, the anode panel 2 has the base portion 2m bent to the cavity 10 side by receiving the atmospheric pressure due to the influence of the vacuuming of the inside of the cavity 10. Therefore, to render the first surface 3 and the third surface 5 flat in the state where the anode panel 2 receives the atmospheric pressure after the vacuuming, the first surface 3 is formed in advance like a convex curve so that the center 3P of the first surface 3 is more projected than its rim 3b, and the third surface 5 is formed in advance like a concave curve so that the center of the third surface 5 is more dented than its rim correspondingly to the first surface 3. Thus, the first surface 3 and the third surface 5 become flat against the principal surface 13x of the cathode panel 12 in the state where the anode panel 2 receives the atmospheric pressure after the vacuuming. Therefore, it is possible, as with the aforementioned first embodiment, to render spaces between the electron sources 14 and the phosphor 7 even so as to obtain the display panel 1 of a good quality without unevenness in luminance.

In this process, as shown in FIG. 11A, the anode panel 2 has the outer rim 4b of the second surface 4 bent as if floating by receiving the atmospheric pressure due to the influence of the vacuuming of the inside of the cavity 10. Therefore, as shown in FIG. 11A, the second surface 4 of the anode panel 2 which was flat against the cathode panel 12 before performing the vacuuming is inclined so that the outer rim 4b is located closer to the first surface 3 side than the inner rim 4a in the direction for crossing the inner rim 4a and the outer rim 4b (width direction of the second surface 4).

Thus, the second surface 4 is inclined so that the thickness of the sealant 9 becomes less inside than outside in the width direction of the second surface 4. Therefore, it is possible to prevent the problem such as dragging the sealant 9 therein during the vacuuming and forming a leak path.

In this process, as shown in FIG. 11B, the anode panel 2 has the angular portions 4b2 of the outer rim 4b of the second surface 4 bent as if floating by receiving the atmospheric pressure due to the influence of the vacuuming of the inside of the cavity 10. Therefore, as shown in FIG. 11B, the second surface 4 of the anode panel 2 which was flat against the cathode panel 12 before performing the vacuuming is curved so that the angular portions 4b2 of the outer rim 4b are located closer to the first surface 3 side than the side center 4b1 of the outer rim 4b in the direction for connecting the two adjacent angular portions 4b2 of the outer rim 4b (longitudinal direction of the second surface 4).

Thus, as the second surface 4 becomes curved, the thickness of the sealant 9 of the angular portions 4b2 of the outer rim 4b becomes larger than that of the side center 4b1 of the outer rim 4b in the longitudinal direction of the second surface 4.

### Third Embodiment

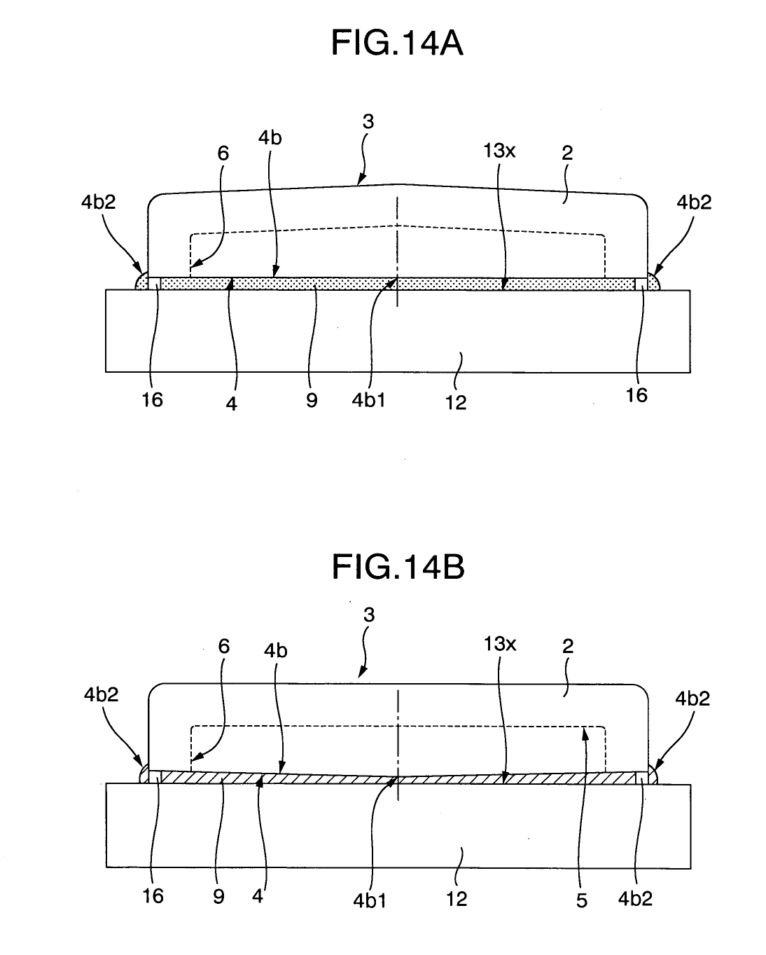

FIGS. 14A and 14B are diagrams showing the sealing process in manufacturing of the display panel according to a third embodiment of the present invention. FIG. 14A is a schematic side view showing the state before the evacuation of air, and FIG. 14B is a schematic side view showing the state after the evacuation of air. The third embodiment is a deformed example of the second embodiment.

According to the second embodiment, if the angular portions (angular portions 4b2 of the outer rim 4b of the second surface 4) of the anode panel 2 float on the vacuuming after the sealant 9 is crushed on sealing, a force acts in the direction for peeling off the sealant 9. As the gap between the principal surface 13x of the cathode panel 12 and the second surface 2 of the anode panel 2 becomes higher, the leak path is generated or the tensile stress remains to lower the reliability unless the sealant 9 is replenished accordingly.

Thus, as shown in FIGS. 14A and 14B, spacers 16 are sandwiched at the angular portions of the anode panel 2 to prevent the sealant 9 from being crushed on sealing. When performing the vacuuming, only the sealant 9 surrounding the angular portions is crushed in reference to the thickness of the sealant 9 at the angular portions. Therefore, it is possible to prevent the tensile stress due to the floating of the angular portions of the anode panel 2. Thus, it is possible to prevent generation of the leak path and remaining of the tensile stress so as to improve the reliability of the sealing portion.

### Fourth Embodiment

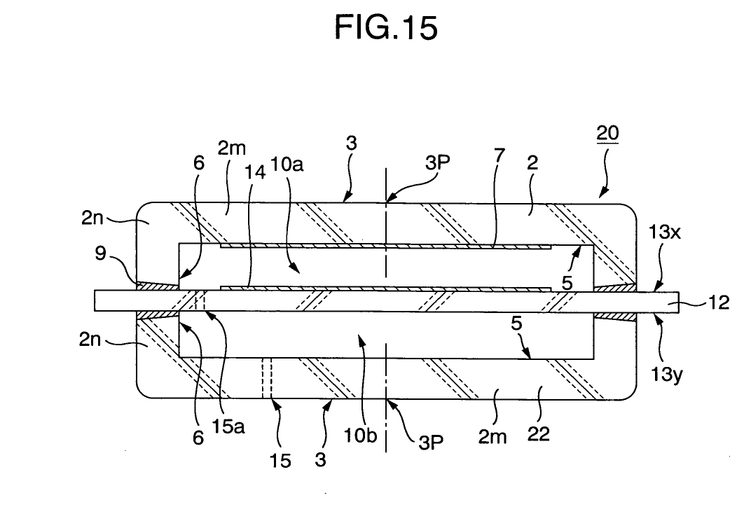

FIGS. 15 to 17 are diagrams related to the display panel according to a fourth embodiment of the present invention.

FIG. 15 is a schematic sectional view showing a general configuration of the display panel.

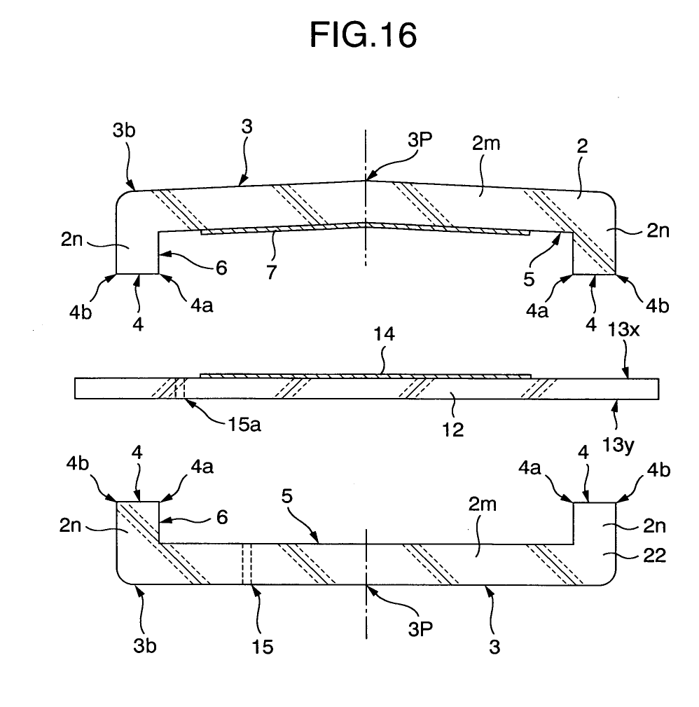

FIG. 16 is an expansion plan of the display panel of FIG. 15.

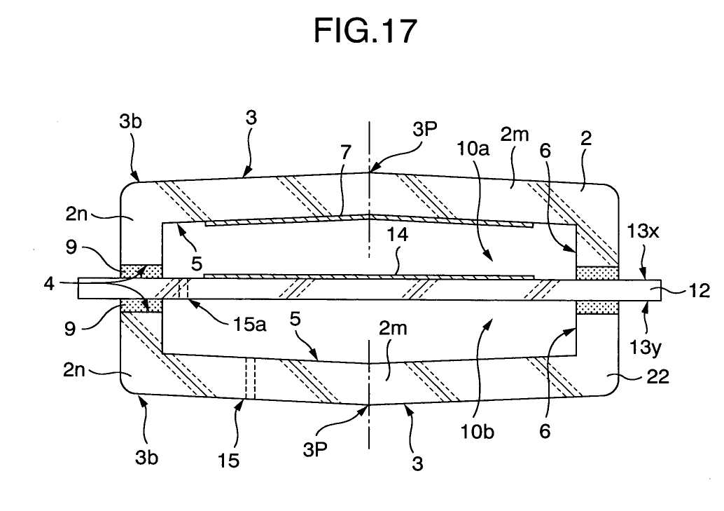

FIG. 17 is a schematic sectional view showing the sealing process in manufacturing of the display panel.

As shown in FIG. 15, a display panel 20 of the fourth embodiment is configured by sandwiching the cathode panel 12 between the anode panel 2 and a backside panel 22 and further including the cavity 10 formed by the anode panel 2 and the cathode panel 12 and a cavity 10a formed by the backside panel 22 and the cathode panel 12.

The anode panel 2 has the same configuration as the anode panel of the aforementioned second embodiment. As shown in FIG. 16, the second surface 3 before the vacuuming is flat against the principal surface 13x of the cathode panel 12.

The backside panel 22 has the same configuration as the anode panel 2. As shown in FIG. 16, the second surface 4 before the vacuuming is flat against the backside 13y of the cathode panel 12. The electron sources 14 are not provided to the backside panel 22.

As shown in FIG. 15, the anode panel 2 and the cathode panel 12 are sealed and firmly fixed by the sealant 9 lying between the second surface 4 of the anode panel 2 and the principal surface 13x of the cathode panel 12. The backside panel 22 and the cathode panel 12 are sealed and firmly fixed by the sealant 9 lying between the second surface 4 of the backside panel 22 and the backside 13y of the cathode panel 12.

The cavity 10 is airtightly sealed by firmly fixing the anode panel 2 and the cathode panel 12 with the sealant 9. The cavity 10a is airtightly sealed by firmly fixing the backside panel 22 and the cathode panel 12 with the sealant 9.

The cathode panel 12 is provided with an air vent 15a for connecting the cavity 10 with the cavity 10a. The backside panel 22 is provided with the exhaust hole 15 for performing vacuuming to the inside of the cavities 10 and 10a. The exhaust hole 15 is closed after performing the vacuuming to the inside of the cavities 10 and 10a so as to keep a vacuum state in the cavities 10 and 10a.

Next, manufacturing of the display panel 20 of the fourth embodiment will be described by using FIG. 17.

First, the anode panel 2, cathode panel 12 and backside panel 22 shown in FIG. 16 are prepared.

Next, as shown in FIG. 17, the sealant 9 is put between the principal surface 13x of the cathode panel 12 and the second surface 4 of the anode panel 2, and the anode panel 2 is placed on the principal surface 13x side of the cathode panel 12 so that the electron sources 14 and the phosphor 7 are opposed to each other. And the sealant 9 is put between the backside 13y of the cathode panel 12 and the second surface 4 of the backside panel 22, and the backside panel 22 is placed on the backside 13y of the cathode panel 12.

Next, the sealant 9 lying between the principal surface 13x of the cathode panel 12 and the second surface 4 of the anode panel 2 and the sealant 9 lying between the backside 13y of the cathode panel 12 and the second surface 4 of the backside panel 22 are melted. Thus, the principal surface 13x of the cathode panel 12 and the second surface 4 of the anode panel 2 are firmly fixed, and the backside 13y of the cathode panel 12 and the second surface 4 of the backside panel 22 are firmly fixed as shown in FIG. 15. These are firmly fixed by performing the vacuuming (evacuation of air) to the inside of the cavity 10 formed by the cathode panel 12 and the anode panel 2 and the cavity 10a formed by the cathode panel 12 and the backside panel 22 in the state of viscosity in which the sealant 9 melts and deforms (refer to FIG. 10) as with the aforementioned first embodiment.

The fourth embodiment has the following effects.

As the cathode panel 12 is not affected by an air pressure difference, it does not deform even if rendered thinner.

As there is no problem in deforming the backside panel 22, it can be rendered thinner and lighter.

As the cathode panel 12 is provided with the air vent 15a, it is possible to evacuate air from one location without generating an air pressure difference by providing the exhaust hole 15 only to the backside panel 22. However, the evacuation of air takes time because the inside of the cavities 10 and 10a must be rendered vacuum.

It is also possible to render the cavity 22 as a getter room.

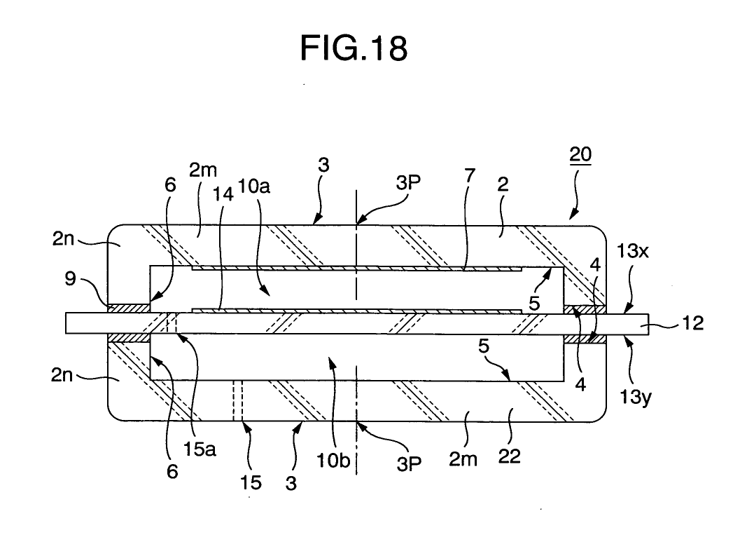

The fourth embodiment describes the example of using the anode panel 2 of which second surface 4 is flat against the principal surface 13x of the cathode panel 12 before performing the vacuuming as with the aforementioned second embodiment (refer to FIGS. 12A and 12B). It is also possible, as with the aforementioned first embodiment (refer to FIGS. 7A and 7B and FIG. 8), to use the anode panel 2 of which second surface 4 is inclined and curved in advance so that the second surface 4 becomes flat against the principal surface 13x of the cathode panel 12 in the state where the anode panel 2 receives the atmospheric pressure after the vacuuming. In this case, the second surface 4 of the anode panel 2 becomes flat against the principal surface 13x of the cathode panel 12 after the vacuuming as shown in FIG. 18 (a schematic sectional view showing an overview configuration of the display panel as a deformed example of the fourth embodiment) so as to have the same effects as the aforementioned first embodiment.

The fourth embodiment also describes the example of using the backside panel 22 of which the second surface 4 is flat against the principal surface 13y of the cathode panel 12 before the vacuuming as with the anode panel 2 of the aforementioned second embodiment (FIGS. 12 (12A and 12B)). It is also possible, as with the aforementioned first embodiment (refer to FIGS. 7 (7A and 7B) and FIG. 8), to use the backside panel 22 of which second surface 4 is inclined and curved in advance so that the second surface 4 becomes flat against the backside 13y of the cathode panel 12 in the state where the backside panel 22 receives the atmospheric pressure after the vacuuming. In this case, second surface 4 of the backside panel 22 becomes flat against the backside 13y of the cathode panel 12 after the vacuuming as shown in FIG. 18 so as to have the same effects as the aforementioned first embodiment.

The above describes the invention made by the inventors hereof concretely based on the embodiments. However, the present invention is not limited to the embodiments but various changes may be made without departing from the scope of the invention as a matter of course.

The above descriptions are given as to the embodiments. However, it will be obvious to those skilled in the art that the present invention is not limited thereto but various changes and modifications may be made without departing from the spirit of the invention and the scope of the attached claims.

1. A method of manufacturing a display panel, comprising the steps of:
(a) preparing an anode panel provided with a phosphor;
(b) preparing a cathode panel provided with electron sources;
(c) sealing the anode panel and the cathode panel by melting a sealant lying between the cathode panel and the anode panel in a state of having the electron sources and the phosphor mutually opposed with a distance between them, and wherein
in the step (c), vacuuming is performed to inside of a cavity formed by the cathode panel and the anode panel in a state of viscosity in which the sealant melts and deforms.

2. The method of manufacturing a display panel according to claim 1, wherein the sealant is a glass frit.

3. A method of manufacturing a display panel, comprising the steps of:
(a) preparing an anode panel including a first surface, a second surface on an opposite side to the first surface, a concave portion with a dent on the second surface to the first surface side and a third surface on its bottom, and a phosphor provided on the third surface;
(b) preparing a cathode panel having electron sources provided on its principal surface;
(c) sealing the anode panel and the cathode panel by melting a sealant lying between the cathode panel and the second surface of the anode panel in a state of having the electron sources and the phosphor mutually opposed with a distance between them, and wherein:
in the step (c), vacuuming is performed to inside of a cavity formed by the cathode panel and the anode panel in a state of viscosity in which the sealant melts and deforms.

4. The method of manufacturing a display panel according to claim 3, wherein the sealant is a glass frit.

5. The method of manufacturing a display panel according to claim 3, wherein the second surface of the anode panel is inclined so as to locate an inner rim on the concave portion side closer to the first surface side than an outer rim on the opposite side to the inner rim in the step (a).

6. The method of manufacturing a display panel according to claim 3, wherein:
the second surface of the anode panel includes the inner rim on the concave portion side and the outer rim on the opposite side to the inner rim;
the inner rim and the outer rim are formed in a square shape; and
the second surface of the anode panel is curved so as to locate a side center of the outer rim closer to the first surface side than angular portions of the outer rim in the step (a).

7. The method of manufacturing a display panel according to claim 3, wherein:
the first surface of the anode panel is formed like a convex curve so as to project the center of the first surface more than its rim in the step (a); and
the third surface of the anode panel is formed like a concave curve so as to dent the center of the third surface more than its rim correspondingly to the first surface in the step (a).

8. A display panel, comprising:
an anode panel including a first surface, a second surface on an opposite side to the first surface, a concave portion with a dent on the second surface to the first surface side and a third surface on its bottom, and a phosphor provided on the third surface; and
a cathode panel having electron sources provided on its principal surface, and wherein:
the cathode panel and the anode panel are sealed by a sealant lying between the cathode panel and the second surface of the anode panel in a state of having the electron sources and the phosphor mutually opposed with a distance between them;
inside of a cavity formed by the cathode panel and the anode panel is more depressurized than outside;
the first and third surfaces of the anode panel are flat; and
the second surface of the anode panel is inclined so as to locate an outer rim on the opposite side to an inner rim closer to the first surface side than the inner rim on the concave portion side.

9. An anode panel comprising:
a first surface;
a second surface on an opposite side to the first surface;
a concave portion with a dent on the second surface to the first surface side and a third surface on its bottom; and
a phosphor provided on the third surface, and wherein:
the second surface is inclined so as to locate an inner rim on the concave portion side closer to the first surface side than an outer rim on the opposite side to the inner rim.

10. An anode panel comprising:
a first surface;
a second surface on an opposite side to the first surface;
a concave portion with a dent on the second surface to the first surface side and a third surface on its bottom; and
a phosphor provided on the third surface, and wherein:
the first surface is formed like a convex curve so as to project a center of the first surface more than its rim; and
the third surface is formed like a concave curve so as to dent the center of the third surface more than its rim correspondingly to the first surface.
